(19) United States
(12) Patent Application Publication
(10) Pub. No.: US 2022/0284318 A1
(43) Pub. Date: Sep. 8, 2022

(54) UTILIZING MACHINE LEARNING MODELS TO DETERMINE ENGAGEMENT STRATEGIES FOR DEVELOPERS

(71) Applicant: Accenture Global Solutions Limited, Dublin (IE)

(72) Inventors: Srikanth G. RAO, Bangalore (IN); Tarun SINGHAL, Bangalore (IN); Arunabh SINHA, Patna (IN); Mathangi SANDILYA, Bangalore (IN); Avishek GULSHAN, Bangalore (IN); Saisandeep SANKU, Bangalore (IN); Gopin NAIR, Kerala (IN)

(21) Appl. No.: 17/189,903

(22) Filed: Mar. 2, 2021

(51) Int. Cl. G06N 5/04; G06N 20/00; G06Q 30/02

(52) U.S. Cl. CPC G06N 5/04; G06N 20/00; G06Q 30/0201; G06Q 10/101

(57) ABSTRACT

A device may receive developer profile data identifying developers associated with different technology communities and technology domains and may assign attributes and weights to the developer profile data to generate weighted developer profile data. The device may utilize a first machine learning model, with the weighted developer profile data, to calculate similarity indexes identifying developers associated with multiple technology communities, and may process the weighted developer profile data and the similarity indexes, with a second machine learning model, to calculate developer activity scores for the technology domains and for developer classifications. The device may identify, based on the developer activity scores, a particular developer profile with a greatest developer activity score, and may process the particular developer profile, with a third machine learning model, to determine an engagement strategy for addressing the particular developer. The device may perform one or more actions based on the engagement strategy.

### BACKGROUND

The Developer Community is growing rapidly across the globe and is expected to reach twenty-eight million members by 2023. Developers play a crucial role in driving adoption of technologies and revenues for technology companies. With growing developer influence on enterprise technology choices and product time to markets, developer sentiment can make or break a technology company. Present day tools and resources lack the capability to monitor the plethora of developer communities (including internal and external developer communities) having millions of active developers and threads, to uniquely identify developers from multi-platform profiles, to prioritize discussion threads that require timely support, or to categorize developers according to their skill and/or knowledge.

### SUMMARY

In some implementations, a method may include receiving developer profile data identifying developers associated with different technology communities and technology domains and assigning attributes and weights to the developer profile data to generate weighted developer profile data. The method may include utilizing a first machine learning model, with the weighted developer profile data, to calculate similarity indexes identifying developers associated with multiple technology communities, and processing the weighted developer profile data and the similarity indexes, with a second machine learning model, to calculate developer activity scores for the technology domains and for developer classifications. The method may include identifying, based on the developer activity scores, a particular developer profile with a greatest developer activity score, and processing the particular developer profile, with a third machine learning model, to determine an engagement strategy for addressing an article associated with the particular developer. The method may include performing one or more actions based on the engagement strategy.

In some implementations, a device includes one or more memories and one or more processors to receive developer profile data identifying developers associated with different technology communities and technology domains and assign attributes and weights to the developer profile data to generate weighted developer profile data. The one or more processors may utilize a first machine learning model, with the weighted developer profile data, to calculate similarity indexes identifying developers associated with multiple technology communities, and may process the weighted developer profile data and the similarity indexes, with a second machine learning model, to calculate developer activity scores for the technology domains and for developer classifications. The one or more processors may identify, based on the developer activity scores, a particular developer profile with a greatest developer activity score, and may process the particular developer profile, with a third machine learning model, to determine an engagement strategy for addressing an article associated with the particular developer. The one or more processors may cause the engagement strategy to be implemented.

In some implementations, a non-transitory computer-readable medium may store a set of instructions that includes one or more instructions that, when executed by one or more processors of a device, cause the device to receive developer profile data identifying developers associated with different technology communities and technology domains, and receive article data identifying articles associated with the developers. The one or more instructions may cause the device to assign attributes and weights to the developer profile data to generate weighted developer profile data, and utilize a first machine learning model, with the weighted developer profile data, to calculate similarity indexes identifying developers associated with multiple technology communities. The one or more instructions may cause the device to process the weighted developer profile data and the similarity indexes, with a second machine learning model, to calculate developer activity scores for the technology domains and for developer classifications, and identify, based on the developer activity scores, a particular developer profile with a greatest developer activity score. The one or more instructions may cause the device to classify intents of the articles to generate classified intents and assign priorities and weights to the classified intents to generate weighted intent data. The one or more instructions may cause the device to utilize a third machine learning model, with the weighted intent data, to calculate weighted priority scores for the articles, and identify, based on the weighted priority scores, a particular article profile with a greatest weighted priority score. The one or more instructions may cause the device to process the particular developer profile or the particular article profile, with a fourth machine learning model, to determine an engagement strategy for addressing the particular developer associated with the particular article profile, and perform one or more actions based on the engagement strategy.

### BRIEF DESCRIPTION OF THE DRAWINGS

FIGS. 1A-1F are diagrams of an example implementation described herein.

FIG. 2 is a diagram illustrating an example of training and using a machine learning model in connection with determining engagement strategies for developers.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning models to determine engagement strategies for developers.

### DETAILED DESCRIPTION

The following detailed description of example implementations refers to the accompanying drawings. The same reference numbers in different drawings may identify the same or similar elements.

With growing developer influence on enterprise technology choices and product time to markets, developer sentiment (e.g., an opinion regarding an ease of use of a product or service, an effectiveness of a product or service, and/or the like) may make or break a technology company. For example, a favorable developer sentiment regarding a product or service provided by a technology company may increase purchasing, use, adoption, and/or the like of the product or service by the developers. It may be beneficial, therefore, for a technology company to monitor developer communities (e.g., both internal and external to technology companies) and/or articles generated by developers to determine current developer sentiment regarding the technology company, determine engagement strategies for engaging with developers to develop products and/or services that address issues faced by developers, and/or the like.

However, there may be multiple developer communities including millions of developers generating millions of articles. Current techniques for determining current developer sentiment lack the capability to monitor multiple developer communities that include millions of active developers and/or articles generated by the developers. Further, current techniques for determining current developer sentiment are also unable to uniquely identify developers from multi-platform profiles, prioritize developer discussion threads that require timely support, and/or categorize developers according to skill and/or knowledge. Thus, current techniques for monitoring developers waste computing resources (e.g., processing resources, memory resources, communication resources, and/or the like), networking resources, and/or the like associated with misinterpreting developer needs, disregarding major problems or prioritizing trivial issues based on the misinterpreted needs, generating negative sentiments that deter other prospective developers from adopting a technology platform, failing to selectively target and interact with developers which leads to a decline in active developers, and/or the like.

Some implementations described herein relate to a profiler system that utilizes machine learning models to determine engagement strategies for developers. For example, the profiler system may receive developer profile data identifying developers associated with different technology communities and technology domains and may assign attributes and weights to the developer profile data to generate weighted developer profile data. The profiler system may utilize a first machine learning model, with the weighted developer profile data, to calculate similarity indexes identifying developers associated with multiple technology communities. The profiler system may process the weighted developer profile data and the similarity indexes, with a second machine learning model, to calculate developer activity scores for the technology domains and for developer classifications. The profiler system may identify, based on the developer activity scores, a particular developer profile with a greatest developer activity score, and may process the particular developer profile, with a third machine learning model, to determine an engagement strategy for addressing the particular developer. The profiler system may perform one or more actions based on the engagement strategy.

In this way, the profiler system utilizes machine learning models to determine engagement strategies for developers. The profiler system may track cross-platform developer behavior and patterns to identify and segment unique developers and may actively engage with the developers to glean insights from community discussions. The profiler system may analyze developer activities across multiple platforms and may identify bona fide developer profiles. The profiler system may discover real challenges faced by developers and may provide timely assistance (e.g., on external forums and communities) without being intrusive. The profiler system may help technology companies enhance engagement with the developer community and increase adoption of their products by the developers. This, in turn, conserves computing resources, networking resources, human resources, and/or the like that would otherwise have been wasted in misinterpreting developer needs, disregarding major problems or prioritizing trivial issues based on the misinterpreted needs, generating negative sentiments that deter other prospective developers from adopting a technology platform, failing to selectively target and interact with developers which leads to a decline in active developers, and/or the like.

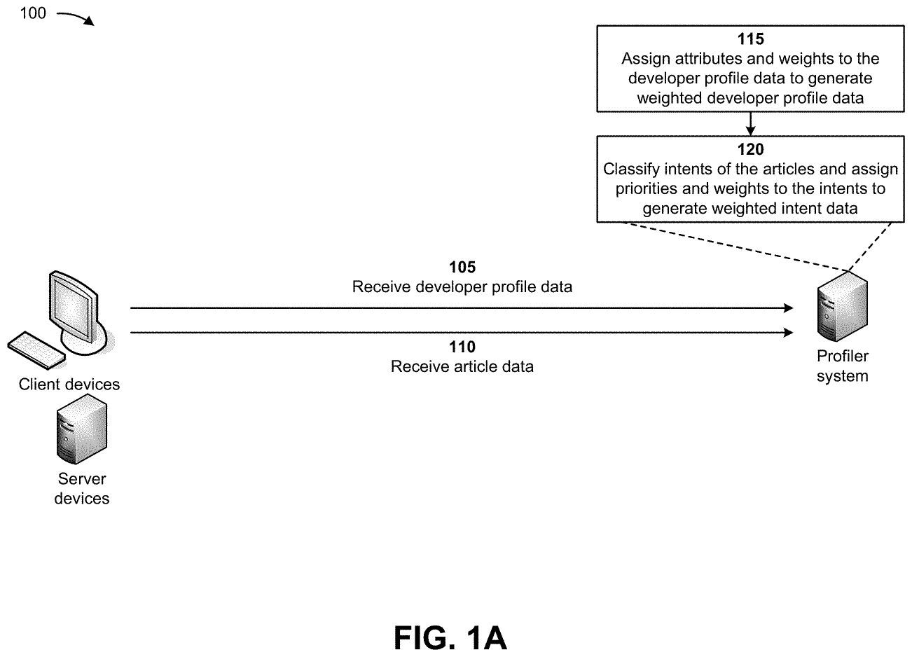

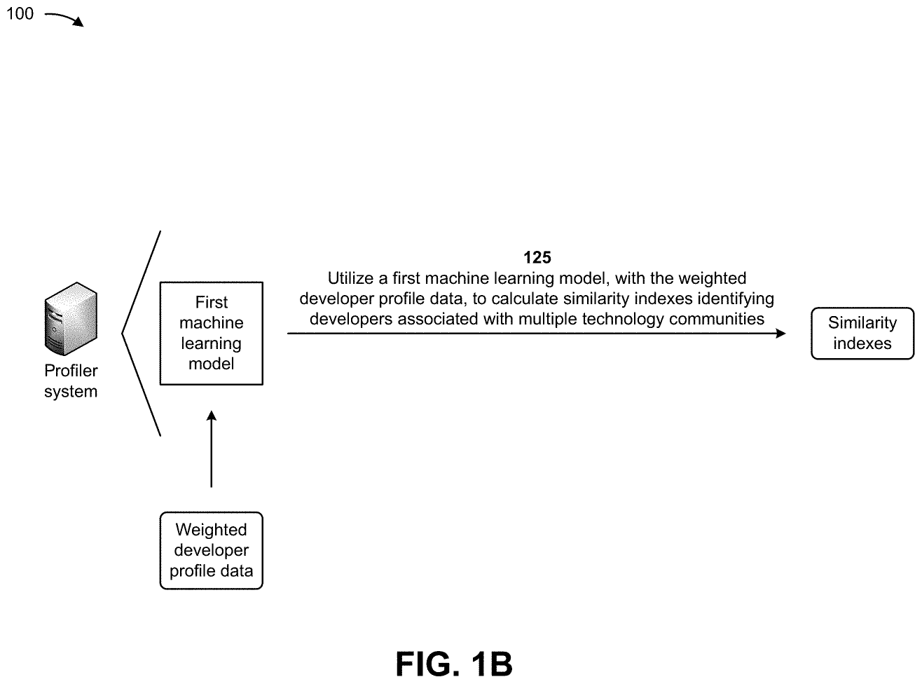

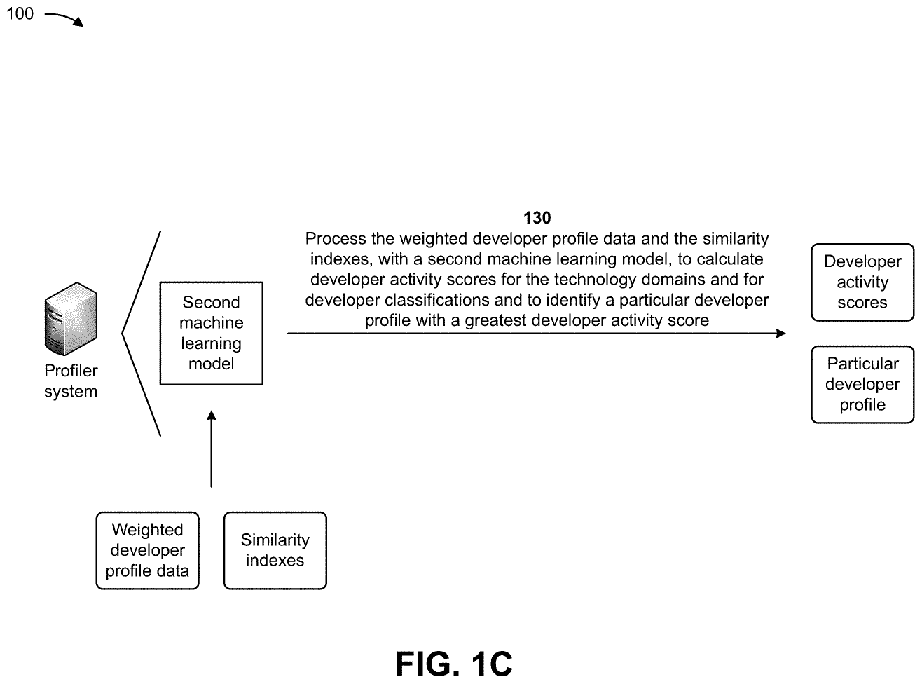

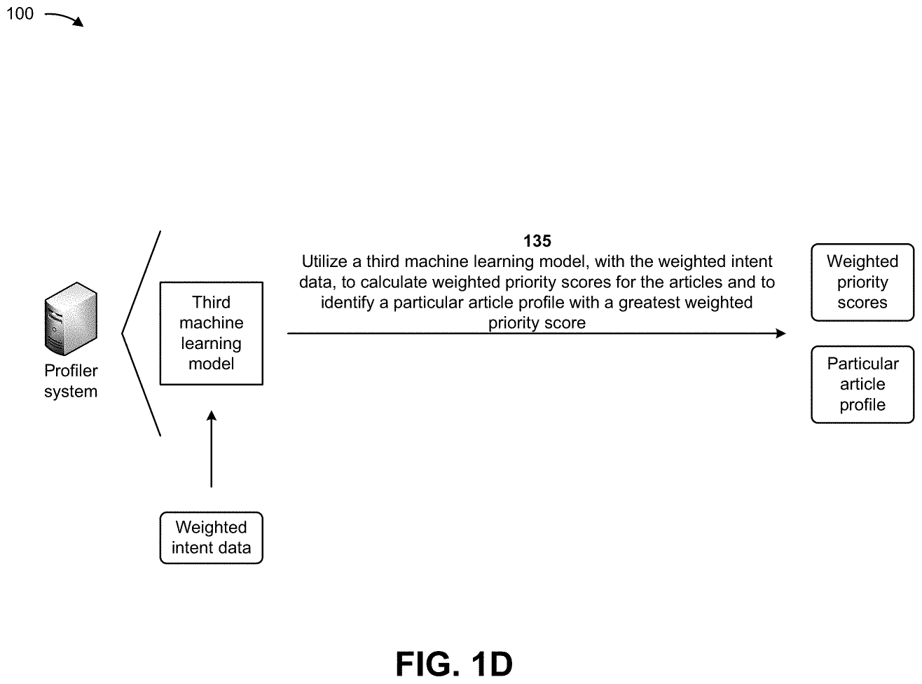

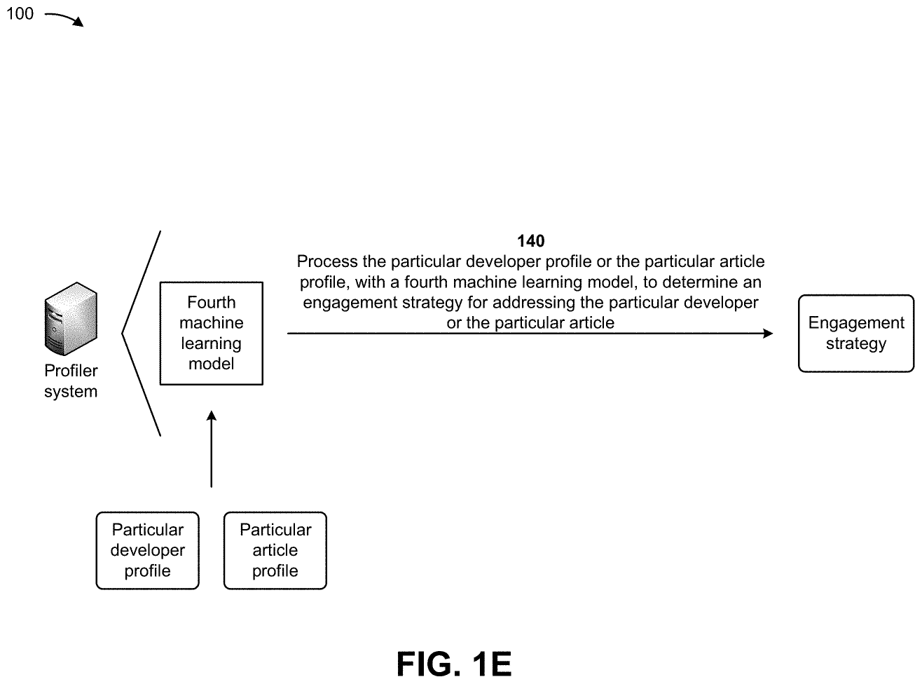

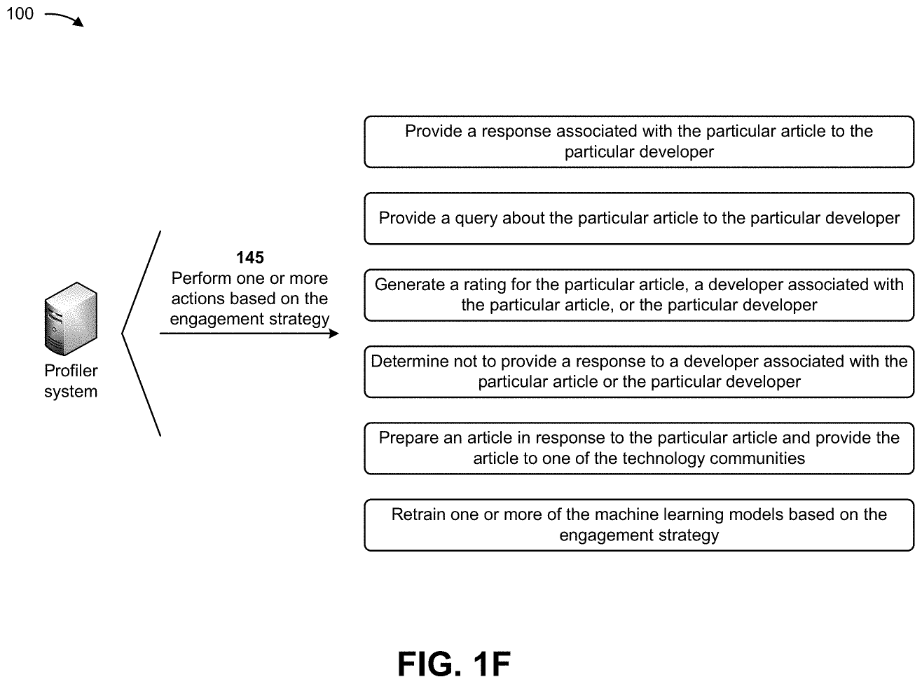

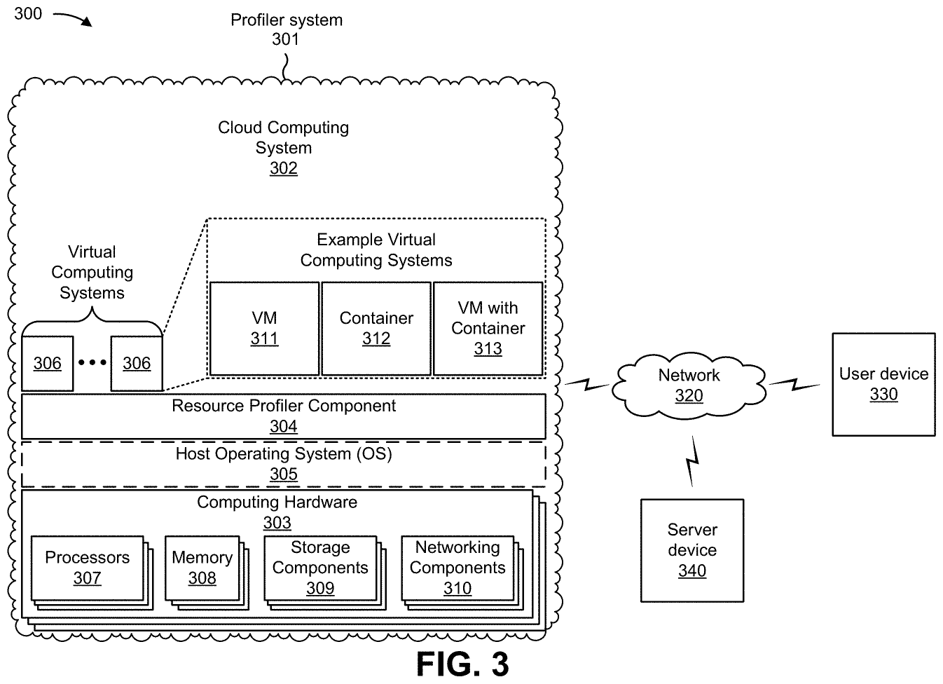

FIGS. 1A-1F are diagrams of an example 100 associated with utilizing machine learning models to determine engagement strategies for developers. As shown in FIGS. 1A-1F, example 100 includes client devices, server devices, and a profiler system. The client devices, the server devices, and the profiler system are described in greater detail below with respect to FIG. 3.

As shown in FIG. 1A, and by reference number 105, the profiler system receives developer profile data from the client devices and/or the server devices. The profiler system may receive the developer profile data periodically (e.g., daily, weekly, monthly, and/or the like), based on an occurrence of an event, based on providing a request for the developer profile data, and/or the like.

The developer profile data may include developer profiles identifying developers associated with different technology communities, different technology domains, and/or the like. For example, a developer profile included in the developer profile data may include information identifying a developer, such as a name of the developer, a username associated with the developer, and/or the like. In some implementations, the information identifying the developer may be associated with a technology community, a technology domain, and/or the like. For example, a developer may use a first username for a first technology community and a second username for a second technology community. The developer profile may include the first username, information associating the first username with the first technology community, the second username, and information associating the second username with the second technology community.

Additionally, the developer profile may include developer data associated with the identified developer. For example, the developer profile associated with a developer may include information identifying a community (e.g., a web site, a blog, and/or the like) in which the developer participates, a technology (e.g., semiconductor devices, wireless networks, network security, and/or the like) associated with the community, a date on which the developer joined the community, a total quantity of times the developer visited the community (e.g., a total quantity of times the developer accessed the web site, the blog, and/or the like), an average quantity of times the developer accessed the community during a time period (e.g., a day, a week, a month, and/or the like), a total quantity of articles submitted to a community by the developer, an average quantity of articles submitted to a community by the developer over a time period (e.g., a day, a week, a month, and/or the like), and/or the like.

As shown by reference number 110, the profiler system receives article data from the client devices and/or the server devices. The profiler system may receive the article data periodically (e.g., daily, weekly, monthly, and/or the like), based on an occurrence of an event, based on providing a request for the article data, and/or the like.

The article data may include article profiles identifying articles (e.g., documents, blog posts, comments, questions, answers to questions, responses, and/or the like) associated with the developer profiles identified in the developer profile data. Additionally, an article profile identified in the article data may include one or more article attributes. An article attribute may identify an identifier associated with an article (e.g., a title) associated with the article profile, a developer who submitted the article, a community to which the article was submitted, a technology associated with the article, a quantity of positive comments posted in reply to the article, a quantity of negative comments posted in reply to the article, information indicating that the article is a parent article (e.g., a first article posted in a discussion thread), information indicating that the article is a child article (e.g., a question, comment, response, and/or the like posted in association with a parent article), information identifying a parent article associated with the article, a topic associated with the article, a technology associated with the article, and/or the like.

As shown by reference number 115, the profiler system assigns attributes and weights to the developer profile data to generate weighted developer profile data. In some implementations, the profiler system may assign attributes and weights to a developer profile included in the developer profile data. The attributes may include quantities of technology conversations conducted by a developer associated with the developer profile (e.g., quantities of articles submitted by the developer), weighted averages of reputations and activities by the developer with the technology communities, ratings associated with the developer, community access frequencies of the developer, an amount of time the developer is active in the technology communities, weighted averages of non-compliant activities by the developer, and/or the like.

As an example, the developer profile data may include a first developer profile associated with a first username and a second developer profile associated with a second username. In some implementations, the first username and the second username are associated with the same developer. For example, a developer may utilize the first username with a first technology community associated with a first technology and may utilize the second username with a second technology community associated with a second technology. In some implementations, the first username and the second username are associated with different developers.

The profiler system may identify a first portion of the article data including article profiles associated with the first username and a second portion of the article data including article profiles associated with the second username. The profiler system may assign attributes and weights to the first developer profile based on the first portion of the article data. The profiler system may assign attributes and weights to the second developer profile based on the second portion of the article data.

In some implementations, the attributes include an attribute associated with a length of time that a developer has been associated with a technology community. As an example, a developer profile may include information indicating a date on which a developer associated with a particular username first accessed, registered with, and/or contributed to a technology community. The profiler system may determine a length of time that the developer was associated with the technology community based on the date. The profiler system may assign the attribute associated with the length of time that a developer has been associated with a technology community to the particular username. The profiler system may assign a weight to the attribute based on the length of time that the developer was associated with the technology community.

In some implementations, the profiler system assigns a first weight based on the length of time satisfying a first time threshold (e.g., less than one year). The profiler system may assign a second weight based on the length of time satisfying a second time threshold (e.g., less than two years, at least one year, and/or the like). The second weight may be greater than the first weight. The profiler system may assign a third weight based on the length of time satisfying a third time threshold (e.g., at least two years). The third weight may be greater than the first weight and/or the second weight.

In some implementations, the attributes include an attribute associated with a quantity of times a developer accessed a technology community over a time period (e.g., a day, a week, a month, and/or the like). As an example, the developer profile may include information indicating a quantity of times a developer associated with a particular username accessed a technology community over a time period. The profiler system may assign the attribute associated with the quantity of times a developer accessed a technology community over a time period to the particular username.

In some implementations, the quantity may be an average quantity of times that the developer accessed the technology community over the time period. The developer profile data may include information indicating a quantity of times the developer accessed the technology community over a period of time corresponding to multiple time periods. The profiler system may determine an average quantity of times that the developer accessed the technology community over the time period based on the quantity of times the developer accessed the technology community over the period of time. The profiler system may determine the quantity based on the average quantity of times the developer accessed the technology community over the time period.

The profiler system may assign a weight to the attribute based on the quantity of times the developer accessed the technology community over the time period. In some implementations, the profiler system assigns a first weight based on the quantity satisfying a first threshold (e.g., once a month, an average of once a month, and/or the like). The profiler system may assign a second weight based on the quantity satisfying a second threshold (e.g., once a week, an average of once a week, and/or the like). The second weight may be greater than the first weight. The profiler system may assign a third weight based on the quantity satisfying a third threshold (e.g., once a day, an average of once a day, and/or the like). The third weight may be greater than the first weight and/or the second weight.

In some implementations, the attributes include an attribute associated with a quantity of articles a developer submitted to a technology community over a time period (e.g., a day, a week, a month, and/or the like). As an example, the developer profile may include information indicating a quantity of articles a developer associated with a particular username submitted to a technology community over a time period. The articles may include a comment to an article submitted by another developer, a question submitted by the developer, a response to a question submitted by another developer, and/or the like. The profiler system may assign the attribute associated with the quantity of articles that a developer submitted to a technology community over a time period to the particular username.

In some implementations, the quantity may be an average quantity of articles that the developer submitted the technology community over the time period. The developer profile data may include information indicating a quantity of articles the developer submitted to the technology community over a period of time corresponding to multiple time periods. The profiler system may determine an average quantity of articles that the developer submitted to the technology community over the time period based on the quantity of articles that the developer submitted to the technology community over the period of time. The profiler system may determine the quantity based on the average quantity of articles that the developer submitted to the technology community over the time period.

In some implementations, the profiler system determines the quantity based on a technology associated with the particular username. The profiler system may identify a set of technology communities associated with a technology based on the developer profile data and/or the article data. The profiler system may determine the quantity based on a total quantity of articles that the developer submitted to the set of technology communities, an average quantity of articles that the developer submitted to the set of technology communities, and/or the like.

The profiler system may assign a weight to the attribute based on the quantity of articles the developer submitted to the technology community over the time period. In some implementations, the profiler system assigns a first weight based on the quantity satisfying a first threshold (e.g., one a month, an average of one a month, and/or the like). The profiler system may assign a second weight based on the quantity satisfying a second threshold (e.g., one a week, an average of one a week, and/or the like). The second weight may be greater than the first weight. The profiler system may assign a third weight based on the quantity satisfying a third threshold (e.g., one a day, an average of one a day, and/or the like). The third weight may be greater than the first weight and/or the second weight.

In some implementations, the attributes include an attribute associated with a frequency at which a developer submitted articles to a technology community over a time period (e.g., a day, a week, a month, and/or the like). As an example, the developer profile may include information indicating a frequency at which a developer associated with a particular username submitted articles to a technology community over a time period. The articles may include a comment to an article submitted by another developer, a question submitted by the developer, a response to a question submitted by another developer, and/or the like. The profiler system may assign the attribute associated with the frequency at which a developer submitted articles to a technology community over a time period to the particular username.

In some implementations, the frequency may be an average frequency at which the developer submitted articles to the technology community over the time period. The developer profile may include information indicating a frequency at which the developer submitted articles to the technology community over a period of time corresponding to multiple time periods. The profiler system may determine an average frequency at which the developer submitted articles to the technology community over the time period based on the frequency at which the developer submitted articles to the technology community over the period of time. The profiler system may determine the frequency based on the average frequency at which the developer submitted articles to the technology community over the time period.

In some implementations, the profiler system determines the frequency based on a technology associated with the particular username. The profiler system may identify a set of technology communities associated with the technology based on the developer profile data and/or the article data. The profiler system may determine the frequency based on a total frequency at which the developer submitted articles to the set of technology communities, an average frequency at which the developer submitted articles to the set of technology communities, and/or the like.

The profiler system may assign a weight to the attribute based on the frequency at which the developer submitted articles to the technology community over the time period. In some implementations, the profiler system assigns a first weight based on the frequency satisfying a first threshold (e.g., once a month, an average of once a month, and/or the like). The profiler system may assign a second weight based on the frequency satisfying a second threshold (e.g., once a week, an average of once a week, and/or the like). The second weight may be greater than the first weight. The profiler system may assign a third weight based on the frequency satisfying a third threshold (e.g., once a day, an average of once a day, and/or the like). The third weight may be greater than the first weight and/or the second weight.

In some implementations, the profiler system assigns one or more additional attributes to the developer profile. The one or more additional attributes may include an attribute associated with a negative article submitted in response to an article submitted by the developer associated with the developer profile (e.g., an article disagreeing with and/or contradicting the article submitted by the developer associated with the developer profile, a dislike, a negative response, a down vote, and/or the like submitted in response to the article submitted by the developer associated with the developer profile, and/or the like), a positive article submitted in response to an article submitted by the developer associated with the developer profile (e.g., an article agreeing with and/or supporting the article submitted by the developer associated with the developer profile, a like, a positive response, an up vote, and/or the like submitted in response to the article submitted by the developer associated with the developer profile, and/or the like), an attribute associated with a ratio of a quantity of articles for which negative articles were submitted in response to a total quantity of articles submitted by the developer associated with the developer profile, an attribute associated with a frequency of articles submitted in response to another article and within a time period (e.g., one hour, two hours, one day, and/or the like) after the other article posted to a technology community, and/or another type of attribute. The profiler system may determine the one or more additional attributes in a manner similar to that described above.

The profiler system may assign weights to the one or more additional attributes in a manner similar to that described above. Alternatively, and/or additionally, the profiler system may assign the weights to the attributes and/or the one or more additional attributes based on a type of article associated with the attributes and/or the one or more additional attributes, a topic associated with the article, and/or the like. For example, the profiler system may assign a first weight based on an article associated with the attribute being a child article, a topic associated with the article not being a relevant topic (e.g., a topic not being included in a list of relevant topics stored in a memory associated with the profiler system, a topic associated with a quantity of articles satisfying a first threshold, a topic not related to a technology associated with a technology community to which the article was submitted, and/or the like), the article not being submitted within a time period after submission of another article to which it is associated, and/or the like. The profiler system may assign a second, greater weight based on the article associated with the attribute being a parent article, a topic associated with the article being a relevant topic (e.g., a topic included in a list of relevant topics stored in a memory associated with the profiler system, a topic associated with a quantity of articles satisfying a second threshold that is greater than the first threshold, a topic related to a technology associated with a technology community to which the article was submitted, and/or the like), the article being submitted within a time period after submission of another article to which it is associated, and/or the like.

As shown by reference number 120, the profiler system classifies intents of the articles and assigns priorities and weights to the intents to generate weighted intent data. The classification of the intents of the articles may include an informational intent (e.g., an article written to provide information to the reader), a navigational intent (e.g., an article written to persuade a reader to navigate to another technology community, another website, another article, and/or the like), a transactional intent (e.g., an article written to persuade a reader to purchase a product and/or a service), a geographically local intent (e.g., an article written for users living within a particular geographic area), and/or the like.

In some implementations, the profiler system determines the intent of an article based on performing natural language processing (NLP). In some implementations, the profiler system performs an NLP technique to pre-process the article. For example, the profiler system may convert text to lowercase, remove punctuation, remove stop words, strip white space, perform stemming, perform lemmatization, spell out abbreviations and acronyms, and/or the like. In some implementations, the profiler system removes sparse words, such as words that are uncommon (e.g., according to a domain-specific corpus, and/or the like). Preprocessing for NLP may improve accuracy of NLP and conserve computing resources that would otherwise be used to perform NLP in a less efficient fashion for an un-preprocessed data set.

In some implementations, the profiler system executes a first NLP technique for analyzing unstructured articles. For example, the profiler system may analyze unstructured articles using a token-based NLP technique (e.g., a technique using regular expressions), a category-based NLP technique (e.g., a named entity recognition (NER) technique), an approximation-based NLP technique (e.g., a fuzzy text search technique), and/or the like. Additionally, or alternatively, the profiler system may analyze structured articles using a second NLP technique (e.g., a metadata-based NLP technique and/or a similar type of technique).

In some implementations, the profiler system executes a token-based NLP technique, such as a technique using regular expressions, to identify the intent. For example, the profile system may reference a data structure that stores regular expressions that may be used to identify an intent associated with the article (e.g., I purchased, you should use, and/or the like). The profile system may use the regular expressions to identify the intent based on comparing the regular expressions and information included in the article.

Additionally, or alternatively, the profile system may execute an approximation-based NLP technique, such as a fuzzy text search technique, to identify the intent. For example, the profile system may execute an approximation-based NLP technique to identify data that satisfies a threshold level of similarity with data stored in a data structure. In this case, the profile system may set a threshold level of similarity (e.g., a percentage, a number of characters, etc.) and may compare information included in the article to information stored in the data structure. If the profile system determines that the threshold level of similarity is satisfied, the profile system may identify the information as information identifying the intent.

In some implementations, the profiler system uses multiple NLP techniques, and filters outputs of the multiple NLP techniques into a set of values identifying the intent. For example, the profile system may identify a first set of values using a first one or more NLP techniques. Additionally, the profile system may identify a second set of values using a second one or more NLP techniques. In some implementations, a mixture of overlapping values and conflicting values may occur. In these implementations, the profile system may address the conflicting values by filtering the first set of values and the second set of values into a third set of values that excludes duplicate values, excludes conflicting values (e.g., by selecting one value, of two conflicting values, using a rule, such a threshold) and/or the like. The profile system may use the third set of values as the set of values identifying the intent.

In some implementations, the profiler system executes one or more of the above-mentioned NLP techniques on a particular type of article, on an article received from a particular server device and/or client device, on a particular field or group of fields within an article, and/or the like. Additionally, or alternatively, the profile system may take an average, or a weighted average, of the outputs of the one or more NLP techniques being deployed to identify the intent. As an example, the profile system may assign a weight to an output associated with each additional NLP technique and may take an average or a weighted average to identify the intent.

The profiler system may determine that the identified intent is associated with a particular classification of intent. For example, the profiler system may determine that the identified intent is associated with a particular classification of intent, a weight associated with the classification of intent, and/or a priority associated with the classification of intent based on accessing a data structure (e.g., a database, a table, a list, and/or the like) storing information mapping intents to classifications of intents, weights associated with the classifications of intents, and/or priorities associated with the classifications of intents.

As shown in FIG. 1B, and by reference number 125, the profiler system utilizes a first machine learning model, with the weighted developer profile data, to calculate similarity indexes identifying developers associated with multiple technology communities. The profiler system may cluster the weighted developer profile data into clusters that correspond to the attributes. The profiler system may determine cluster values based on clustering the weighted developer profile data into the clusters. The profiler system may apply different weights to the cluster values to generate weighted cluster values. The profiler system may calculate the similarity indexes based on the weighted cluster values.

As shown in FIG. 1C, and by reference number 130, the profiler system processes the weighted developer profile data and the similarity indexes, with a second machine learning model, to calculate developer activity scores for the technology domains and for developer classifications and to identify a particular developer profile with a greatest developer activity score. The developer classifications may include an active classification, an expert classification, a clueless classification, a malicious classification, a beginner classification, and/or an influencer classification. The active classification may be associated with a developer that frequently visits a technology community and/or frequently participates in a technology community. For example, the active classification may be associated with a developer that visits a technology community at least a threshold quantity of times over a time period (e.g., once a day, five times a week, and/or the like) and/or submits a threshold quantity of articles.

The expert classification may be associated with a developer that exhibits a deep understanding of a technology domain. For example, the developer may provide accurate responses to queries, may submit articles associated with a threshold quantity of positive articles, and/or the like.

The clueless classification may be associated with a developer that exhibits a lack of an understanding of a technology domain. For example, the developer may submit articles that are unrelated and/or irrelevant to the technology domain and/or an article to which the article is submitted in response.

The malicious classification may be associated with a developer that submits articles that intentionally spread misinformation about a product or a service. For example, the developer may submit articles that include false statements about a product or a service.

The beginner classification may be associated with a developer that exhibits an entry level understanding of a technology and/or is unable to meaningfully contribute to a technology conversation within a technology community. For example, the developer may submit questions regarding basic principles of a technology, exhibit an inability to comprehend relatively complex discussions within a technology community, and/or the like.

The influencer classification may be associated with a developer that is well respected within a technology community and/or submits articles that tend to influence the opinions of other developers. For example, the developer may submit articles to which over a threshold quantity of positive articles are submitted in response, is highly ranked on a leaderboard associated with a technology community, and/or the like.

In some implementations, the profiler system clusters, based on the similarity indexes, the weighted developer profile data into clusters that correspond to the developer classifications. In some implementations, the second machine learning model includes a k-means clustering model, and the developer classifications correspond to clusters of the k-means clustering model. The profiler system may apply different weights to the weighted developer profile data in each of the clusters. The profiler system may calculate the developer activity scores based on applying the different weights to the weighted developer profile data. The profiler system may identify a particular developer profile associated with a greatest developer activity score relative to the developer profile scores associated with other developer profiles.

As shown in FIG. 1D, and by reference number 135, the profiler system utilizes a third machine learning model, with the weighted intent data, to calculate weighted priority scores for the articles and to identify a particular article profile with a greatest weighted priority score. The profiler system may classify intents of the articles to generate classified intents. The intents of the articles may include an informational intent, a navigational intent, a transactional intent, and/or a geographically local intent. The profiler system may assign priorities and weights to the classified intents to generate weighted intent data. The profiler system may utilize the third machine learning model, with the weighted intent data, to calculate weighted priority scores for the articles. The profiler system may identify, based on the weighted priority scores, a particular article profile with a greatest weighted priority score relative to weighted priority scores of other article profiles.

As shown in FIG. 1E, and by reference number 140, the profiler system processes the particular developer profile and/or the particular article profile, with a fourth machine learning model, to determine an engagement strategy for addressing an article associated with the particular developer profile and/or the particular article profile. The engagement strategy may include providing assistance to a developer associated with the particular developer profile, tracking or monitoring the developer, providing a query to the developer, providing a response to a query associated with the article, generating a rating for the developer, providing the rating to the developer, and/or the like, as described in greater detail below.

As shown in FIG. 1F, and by reference number 145, the profiler system may perform one or more actions based on the engagement strategy. In some implementations, the one or more actions include the profiler system providing a response associated with a particular article profile to a particular developer. For example, the particular article profile may be associated with a particular article corresponding to a query. The profiler system may determine that the particular article is associated with a particular developer associated with the particular developer profile. The profiler system may provide a response to the query to the particular developer based on the particular developer being associated with the particular article.

As another example, the profiler system may determine that the particular article and/or the particular developer is negatively impacting the reputation of one of the technology domains based on the rating generated for the particular developer. The profiler system may provide a response to the particular developer regarding the particular article to improve the reputation of the technology domain. In some implementations, the response may include an article and the one or more actions may include the profiler system preparing the article in response to the particular article and providing the article to a technology community.

In some implementations, the one or more actions may include the profiler system providing a query about the particular article to the particular developer. For example, the profiler system may determine that the particular article is associated with utilizing particular technology to perform a particular task. The profiler system may provide a query to the particular developer to ask the particular developer whether they would like additional information and/or assistance associated with performing the particular task.

In some implementations, the one or more actions may include the profiler system generating a rating for the particular article, a developer associated with the particular article, and/or the particular developer. The rating may indicate that the particular article, the developer associated with the particular article, and/or the particular developer is associated with a negative impact, a positive impact, and/or the like on a technology and/or a technology community associated with the particular article, the developer associated with the particular article, and/or the particular developer.

In some implementations, the one or more actions may include the profiler system determining not to provide a response to the particular article and/or the particular developer. For example, the profiler system may determine that the particular developer is associated with the clueless classification. The profiler system may determine not to provide a response to the particular article based on the particular developer being associated with the clueless classification. In some implementations, the profiler system may determine that the particular article and/or the particular developer is negatively impacting the reputation of a technology and/or a technology community based on a rating generated based on the weighted priority scores for the particular article and/or particular developer. The profiler system may provide a response to the particular article based on the particular article and/or the particular developer negatively impacting the reputation of the technology and/or the technology community.

In some implementations, the one or more actions include the profiler system retraining one or more of the first machine model, the second machine learning model, the third machine learning model, and/or the fourth machine learning model based on the engagement strategy. The profiler system may utilize the engagement strategy as additional training data for retraining the first machine model, the second machine learning model, the third machine learning model, and/or the fourth machine learning model, thereby increasing the quantity of training data available for training the first machine model, the second machine learning model, the third machine learning model, and/or the fourth machine learning model. Accordingly, the profiler system may conserve computing resources associated with identifying, obtaining, and/or generating historical data for training the first machine model, the second machine learning model, the third machine learning model, and/or the fourth machine learning model relative to other systems for identifying, obtaining, and/or generating historical data for training machine learning models.

In this way, the profiler system utilizes machine learning models to determine engagement strategies for developers. The profiler system may track cross-platform developer behavior and patterns to identify and segment unique developers and may actively engage with the developers to glean insights from community discussions. The profiler system may analyze developer activities across multiple platforms and may identify bona fide developer profiles. The profiler system may discover real challenges faced by developers and may provide timely assistance (e.g., on external forums and communities) without being intrusive. The profiler system may help technology companies enhance engagement with the developer community and increase adoption of their products by the developers. This, in turn, conserves computing resources, networking resources, human resources, and/or the like that would otherwise have been wasted in misinterpreting developer needs, disregarding major problems and/or prioritizing trivial issues based on misinterpreted developer needs, generating negative developer sentiments that deter developers from adopting a technology platform, failing to selectively target and interact with developers which leads to a decline in active developers, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

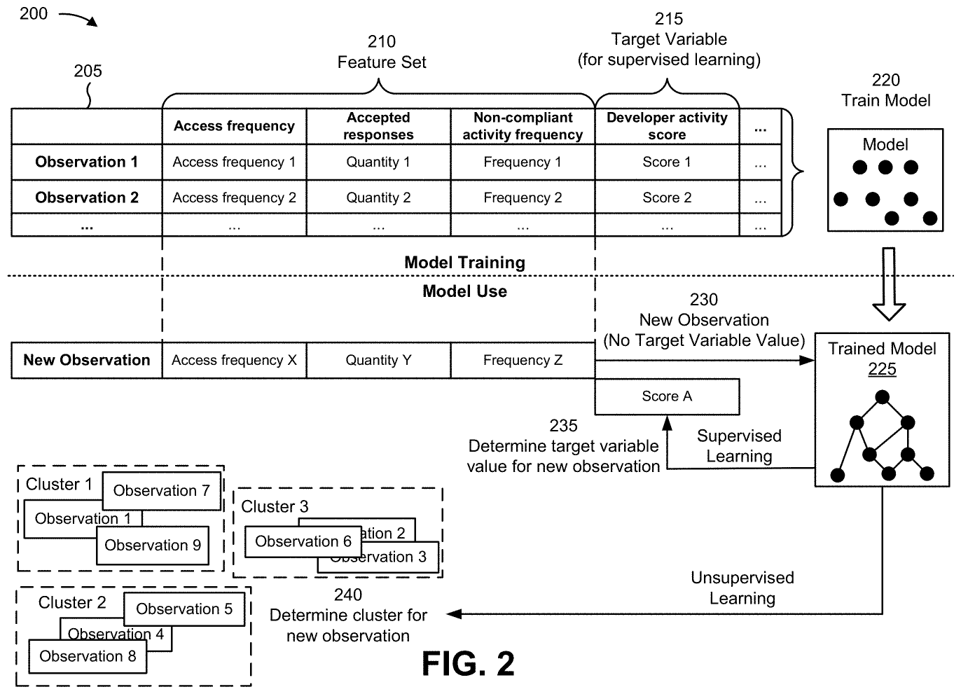

FIG. 2 is a diagram illustrating an example 200 of training and using a machine learning model (e.g., the first machine learning model, the second machine learning model, the third machine learning model, and/or the fourth machine learning model) in connection with determining strategies for developers. The machine learning model training and usage described herein may be performed using a machine learning system. The machine learning system may include or may be included in a computing device, a server, a cloud computing environment, and/or the like, such as the profiler system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the profiler system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the profiler system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of an access frequency, a second feature of accepted responses, a third feature of non-compliant activity score, and so on. As shown, for a first observation, the first feature may have a value of access frequency 1, the second feature may have a value of quantity 1, the third feature may have a value of frequency 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is a developer activity score, which has a value of score 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of access frequency X, a second feature of quantity Y, a third feature of frequency Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of score A for the target variable of the developer activity score for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., an access frequency cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., an accepted responses cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to determine engagement strategies for developers. The machine learning system enables recognition and/or identification of tens, hundreds, thousands, or millions of features and/or feature values for tens, hundreds, thousands, or millions of observations, thereby increasing accuracy and consistency and reducing delay associated with determining engagement strategies for developers relative to requiring computing resources to be allocated for tens, hundreds, or thousands of operators to manually determine engagement strategies for developers.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a profiler system 301, which may include one or more elements of and/or may execute within a cloud computing system 302. The cloud computing system 302 may include one or more elements 303-313, as described in more detail below. As further shown in FIG. 3, environment 300 may include a network 320, a client device 330, and/or a server device 340. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

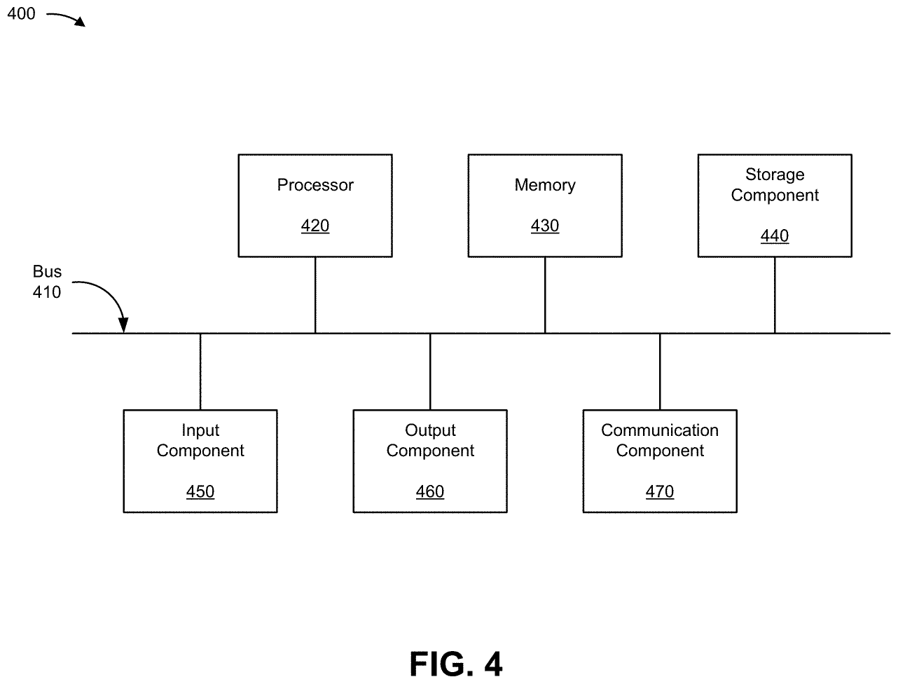

Although the profiler system 301 may include one or more elements 303-313 of the cloud computing system 302, may execute within the cloud computing system 302, and/or may be hosted within the cloud computing system 302, in some implementations, the profiler system 301 may not be cloud-based (e.g., may be implemented outside of a cloud computing system) or may be partially cloud-based. For example, the profiler system 301 may include one or more devices that are not part of the cloud computing system 302, such as device 400 of FIG. 4, which may include a standalone server or another type of computing device. The profiler system 301 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, and/or the like, and/or a combination of these or other types of networks. The network 320 enables communication among the devices of environment 300.

Client device 330 includes one or more devices capable of receiving, generating, storing, processing, and/or providing information, as described elsewhere herein. Client device 330 may include a communication device and/or a computing device. For example, client device 330 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. Client device 330 may communicate with one or more other devices of environment 300, as described elsewhere herein.

Server device 340 includes one or more devices capable of receiving, generating, storing, processing, providing, and/or routing information, as described elsewhere herein. Server device 340 may include a communication device and/or a computing device. For example, server device 340 may include a server, such as an application server, a client server, a web server, a database server, a host server, a proxy server, a virtual server (e.g., executing on computing hardware), or a server in a cloud computing system. In some implementations, server device 340 includes computing hardware used in a cloud computing environment.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to profiler system 301, client device 330, and/or server device 340. In some implementations, profiler system 301, client device 330, and/or server device 340 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random-access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid-state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, an actuator, and/or the like. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, an antenna, and/or the like.

Device 400 may perform one or more processes described herein. For example, a non-transitory computer-readable medium (e.g., memory 430 and/or storage component 440) may store a set of instructions (e.g., one or more instructions, code, software code, program code, and/or the like) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

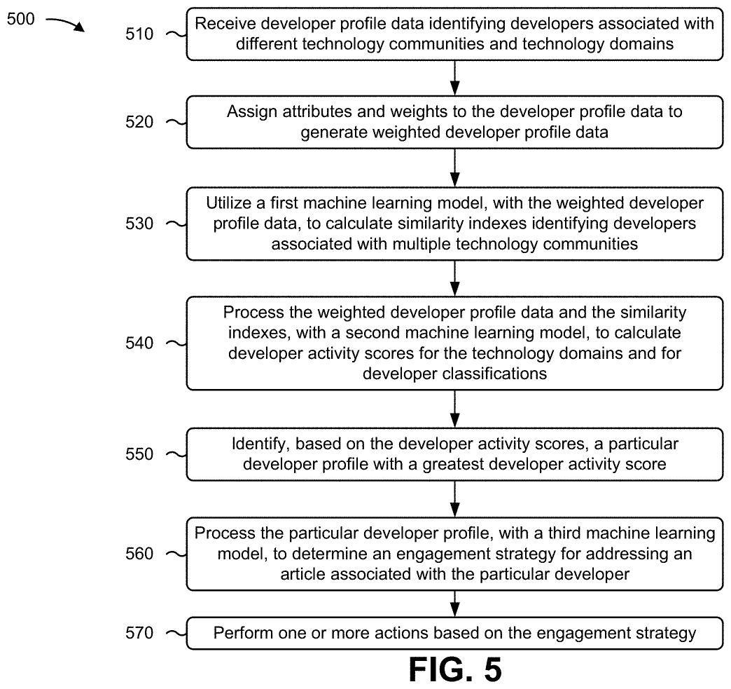

FIG. 5 is a flowchart of an example process 500 for utilizing machine learning models to determine engagement strategies for developers. In some implementations, one or more process blocks of FIG. 5 may be performed by a device (e.g., profiler system 301). In some implementations, one or more process blocks of FIG. 5 may be performed by another device or a group of devices separate from or including the device, such as a client device (e.g., client device 330) and/or a server device (e.g., server device 340). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving developer profile data identifying developers associated with different technology communities and technology domains (block 510). For example, the device may receive developer profile data identifying developers associated with different technology communities and technology domains, as described above.

As further shown in FIG. 5, process 500 may include assigning attributes and weights to the developer profile data to generate weighted developer profile data (block 520). For example, the device may assign attributes and weights to the developer profile data to generate weighted developer profile data, as described above. The attributes may include quantities of technology conversations conducted by the developers, weighted averages of reputations and activities by the developers with the technology communities, ratings of the developers, community access frequencies of the developers, times active in the technology communities by the developers, and/or weighted averages of non-compliant activities by the developers.

As further shown in FIG. 5, process 500 may include utilizing a first machine learning model, with the weighted developer profile data, to calculate similarity indexes identifying developers associated with multiple technology communities (block 530). For example, the device may utilize a first machine learning model, with the weighted developer profile data, to calculate similarity indexes identifying developers associated with multiple technology communities, as described above.

In some implementations, the device may cluster the weighted developer profile data into clusters that correspond to the attributes. The device may determine cluster values based on clustering the weighted developer profile data into the clusters. The device may apply different weights to the cluster values to generate weighted cluster values. The device may calculate the similarity indexes based on the weighted cluster values.

As further shown in FIG. 5, process 500 may include processing the weighted developer profile data and the similarity indexes, with a second machine learning model, to calculate developer activity scores for the technology domains and for developer classifications (block 540). For example, the device may process the weighted developer profile data and the similarity indexes, with a second machine learning model, to calculate developer activity scores for the technology domains and for developer classifications, as described above.

In some implementations, the device may cluster, based on the similarity indexes, the weighted developer profile data into clusters that correspond to the developer classifications. The device may apply different weights to the weighted developer profile data in each of the clusters. The device may calculate the developer activity scores based on applying the different weights to the weighted developer profile data.

In some implementations, the second machine learning model includes a k-means clustering model, and the developer classifications correspond to clusters of the k-means clustering model. The clusters of the k-means clustering model may include one or more of an active classification, an expert classification, a clueless classification, a malicious classification, a beginner classification, or an influencer classification.

As further shown in FIG. 5, process 500 may include identifying, based on the developer activity scores, a particular developer profile with a greatest developer activity score (block 550). For example, the device may identify, based on the developer activity scores, a particular developer profile with a greatest developer activity score, as described above.

As further shown in FIG. 5, process 500 may include processing the particular developer profile, with a third machine learning model, to determine an engagement strategy for addressing an article associated with the particular developer (block 560). For example, the device may process the particular developer profile, with a third machine learning model, to determine an engagement strategy for addressing an article associated with the particular developer, as described above.

As further shown in FIG. 5, process 500 may include performing one or more actions based on the engagement strategy (block 570). For example, the device may perform one or more actions based on the engagement strategy, as described above. In some implementations, performing the one or more actions may include providing a response to the article associated with the particular developer, providing a query to the particular developer, retraining one or more of the first machine learning model, the second machine learning model or the third machine learning model based on the engagement strategy, generating a rating for the particular developer, and/or providing the rating for the particular developer.

In some implementations, the device may determine that the particular developer positively impacted a reputation of one of the technology domains. For example, the device may determine that the particular developer positively impacted the reputation of one of the technology domains based on the rating generated for the particular developer. The device may provide assistance to the particular developer and/or may track the particular developer based on the particular developer positively impacting the reputation of one of the technology domains.

In some implementations, the device may determine that the particular developer is negatively impacting a reputation of one of the technology domains. For example, the device may determine that the particular developer is negatively impacting the reputation of one of the technology domains based on the rating generated for the particular developer. The device may provide a response to the particular developer to improve the reputation of the one of the technology domains. Alternatively, and/or additionally, the device may prevent engagement with the particular developer.

In some implementations, the device may receive article data identifying articles associated with the developers. The device may classify intents of the articles to generate classified intents. The intents of the articles may include informational intent, navigational intent, transactional intent, and/or geographically local intent. The device may assign priorities and weights to the classified intents to generate weighted intent data. The device may utilize a fourth machine learning model, with the weighted intent data, to calculate weighted priority scores for the articles. The device may identify, based on the weighted priority scores, a particular article profile with a greatest weighted priority score. The device may process the particular article profile, with the third machine learning model, to determine another engagement strategy for addressing a particular article associated with the particular article profile.

The device may perform one or more additional actions based on the other engagement strategy. In some implementations, performing the one or more additional actions may include providing a response associated with the particular article, providing a query about the particular article, generating a rating for the particular article or for a developer associated with the particular article, and/or providing the rating for the particular article or for the developer associated with the particular article. Alternatively, and/or additionally, performing the one or more additional actions may include determining not to provide a response to the particular article, preparing an article in response to the particular article and providing the article to one of the technology communities, and/or retraining one or more of the first machine learning model, the second machine learning model, the third machine learning model, or the fourth machine learning model based on the engagement strategy.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, developer profile data identifying developers associated with different technology communities and technology domains;
assigning, by the device, attributes and weights to the developer profile data to generate weighted developer profile data;
utilizing, by the device, a first machine learning model, with the weighted developer profile data, to calculate similarity indexes identifying developers associated with multiple technology communities;
processing, by the device, the weighted developer profile data and the similarity indexes, with a second machine learning model, to calculate developer activity scores for the technology domains and for developer classifications;
identifying, by the device based on the developer activity scores, a particular developer profile with a greatest developer activity score;
processing, by the device, the particular developer profile, with a third machine learning model, to determine an engagement strategy for addressing a particular article associated with the particular developer; and
performing, by the device, one or more actions based on the engagement strategy.

2. The method of claim 1, further comprising:
receiving article data identifying articles associated with the developers;
classifying intents of the articles to generate classified intents;
assigning priorities and weights to the classified intents to generate weighted intent data;
utilizing a fourth machine learning model, with the weighted intent data, to calculate weighted priority scores for the articles;
identifying, based on the weighted priority scores, a particular article profile with a greatest weighted priority score;
processing the particular article profile, with the third machine learning model, to determine another engagement strategy for addressing the particular article profile; and
performing one or more additional actions based on the other engagement strategy.

3. The method of claim 2, wherein performing the one or more additional actions comprises one or more of:
providing a response associated with the particular article;
providing a query about the particular article; or
generating and providing a rating for the particular article or for a developer associated with the particular article.

4. The method of claim 2, wherein the intents of the articles include one or more of:
informational intent,
navigational intent,
transactional intent, or
geographically local intent.

5. The method of claim 2, wherein performing the one or more additional actions comprises one or more of:
determining not to provide a response to the particular article;
preparing an article in response to the particular article and providing the article to one of the technology communities; or
retraining one or more of the first machine learning model, the second machine learning model, the third machine learning model, or the fourth machine learning model based on the engagement strategy.

6. The method of claim 1, wherein performing the one or more actions comprises one or more of:
providing a response to the particular developer;
providing a query to the particular developer; or
generating and providing a rating for the particular developer.

7. The method of claim 1, wherein performing the one or more actions comprises one or more of:
monitoring articles associated with the particular developer; or
retraining one or more of the first machine learning model, the second machine learning model, or the third machine learning model based on the engagement strategy.

8. A device, comprising:
one or more memories; and
one or more processors, communicatively coupled to the one or more memories, configured to:
receive developer profile data identifying developers associated with different technology communities and technology domains;
assign attributes and weights to the developer profile data to generate weighted developer profile data;
utilize a first machine learning model, with the weighted developer profile data, to calculate similarity indexes identifying developers associated with multiple technology communities;
process the weighted developer profile data and the similarity indexes, with a second machine learning model, to calculate developer activity scores for the technology domains and for developer classifications;
identify, based on the developer activity scores, a particular developer profile with a greatest developer activity score;
process the particular developer profile, with a third machine learning model, to determine an engagement strategy for addressing an article associated with the particular developer; and
cause the engagement strategy to be implemented.

9. The device of claim 8, wherein the attributes include one or more of:
quantities of technology conversations conducted by the developers;
weighted averages of reputations and activities by the developers with the technology communities;
ratings of the developers;
community access frequencies of the developers;
times active in the technology communities by the developers; or
weighted averages of non-compliant activities by the developers.

10. The device of claim 8, wherein the second machine learning model includes a k-means clustering model and the developer classifications correspond to clusters of the k-means clustering model and include one or more of:
an active classification,
an expert classification,
a clueless classification,
a malicious classification,
a beginner classification, or
an influencer classification.

11. The device of claim 8, wherein the one or more processors, when processing the weighted developer profile data and the similarity indexes, with the second machine learning model, to calculate the developer activity scores, are configured to:
cluster, based on the similarity indexes, the weighted developer profile data into clusters that correspond to the developer classifications;
apply different weights to the weighted developer profile data in each of the clusters; and
calculate the developer activity scores based on applying the different weights to the weighted developer profile data.

12. The device of claim 8, wherein the one or more processors, when utilizing the first machine learning model, with the weighted developer profile data, to calculate the similarity indexes, are configured to:
cluster the weighted developer profile data into clusters that correspond to the attributes;
determine cluster values based on clustering the weighted developer profile data into the clusters;
apply different weights to the cluster values to generate weighted cluster values; and
calculate the similarity indexes based on the weighted cluster values.

13. The device of claim 8, wherein the one or more processors are further configured to one or more of:
provide assistance to the particular developer; or
track the particular developer based on the particular developer positively impacting a reputation of one of the technology domains.

14. The device of claim 8, wherein the one or more processors are further configured to:
determine that the particular developer is negatively impacting a reputation of one of the technology domains; and
provide a response to the article associated with the particular developer to improve the reputation of the one of the technology domains.

15. A non-transitory computer-readable medium storing a set of instructions, the set of instructions comprising:
one or more instructions that, when executed by one or more processors of a device, cause the device to:
receive developer profile data identifying developers associated with different technology communities and technology domains;
receive article data identifying articles associated with the developers;
assign attributes and weights to the developer profile data to generate weighted developer profile data;
utilize a first machine learning model, with the weighted developer profile data, to calculate similarity indexes identifying developers associated with multiple technology communities;
process the weighted developer profile data and the similarity indexes, with a second machine learning model, to calculate developer activity scores for the technology domains and for developer classifications;
identify, based on the developer activity scores, a particular developer profile with a greatest developer activity score;
classify intents of the articles to generate classified intents;
assign priorities and weights to the classified intents to generate weighted intent data;
utilize a third machine learning model, with the weighted intent data, to calculate weighted priority scores for the articles;
identify, based on the weighted priority scores, a particular article profile with a greatest weighted priority score;
process the particular developer profile or the particular article profile, with a fourth machine learning model, to determine an engagement strategy for addressing the particular developer associated with the particular article profile; and
perform one or more actions based on the engagement strategy.

16. The non-transitory computer-readable medium of claim 15, wherein the one or more instructions, that cause the device to perform the one or more actions, cause the device to:
provide a response associated with the particular article or to the particular developer;
provide a query about the particular article or to the particular developer; or
generate and provide a rating for the particular article, for a developer associated with the particular article, or for the particular developer.

17. The non-transitory computer-readable medium of claim 15, wherein the one or more instructions, that cause the device to perform the one or more actions, cause the device to:
determine not to provide a response to the particular article;
prepare an article in response to the particular article and provide the article to one of the technology communities; or
retrain one or more of the first machine learning model, the second machine learning model, the third machine learning model, or the fourth machine learning model based on the engagement strategy.

18. The non-transitory computer-readable medium of claim 15, wherein the one or more instructions, that cause the device to process the weighted developer profile data and the similarity indexes, with the second machine learning model, to calculate the developer activity scores, cause the device to:
cluster, based on the similarity indexes, the weighted developer profile data into clusters that correspond to the developer classifications;
apply different weights to the weighted developer profile data in each of the clusters; and
calculate the developer activity scores based on applying the different weights to the weighted developer profile data.

19. The non-transitory computer-readable medium of claim 15, wherein the one or more instructions, that cause the device to utilize the first machine learning model, with the weighted developer profile data, to calculate the similarity indexes, cause the device to:
cluster the weighted developer profile data into clusters that correspond to the attributes;
determine cluster values based on clustering the weighted developer profile data into the clusters;
apply different weights to the cluster values to generate weighted cluster values; and
calculate the similarity indexes based on the weighted cluster values.

20. The non-transitory computer-readable medium of claim 15, wherein the one or more instructions, that cause the device to perform the one or more actions, cause the device to one or more of:
provide assistance to the particular developer;
track the particular developer based on the particular developer positively impacting a reputation of one of the technology domains; or
determine that the particular developer is negatively impacting a reputation of one of the technology domains and provide a response to the article to improve the reputation of the one of the technology domains.
